(19) United States
(12) Patent Application Publication
(10) Pub. No.: US 2019/0022990 A1
(43) Pub. Date: Jan. 24, 2019

(54) SELF-HEALING OF TOUCH-SURFACE COMPONENTS

(71) Applicant: HEWLETT-PACKARD DEVELOPMENT COMPANY, L.P., HOUSTON, TX (US)

(72) Inventors: KUAN-TING WU, Taipei City, (TW); Hung-Ming CHEN, Taipei City, (TW); Shan-Chih CHEN, Taipei City (TW)

(21) Appl. No.: 16/067,758

(22) PCT Filed: Apr. 4, 2016
(86) PCT No.: PCT/US2016/025838

§ 371 Date: Jul. 2, 2018

(51) Int. Cl. B32B 27/40; B32B 27/38; B32B 27/36; B32B 27/28; B32B 27/08; B32B 7/02; B32B 7/12; G06F 3/0354

(52) U.S. Cl. CPC B32B 27/40; G06F 2203/04103; B32B 27/36; B32B 27/283; B32B 27/08; B32B 7/02; B32B 7/12; G06F 3/03547; B32B 2305/54; B32B 2307/4026; B32B 2307/762; B32B 2255/10; B32B 2255/26; B32B 2457/208; B32B 27/38

(57) ABSTRACT

The present subject matter relates to self-healing touch-surface components. In an example implementation, a self-healing touch-surface component of an electronic device comprises a self-healing layer disposed over a touch-surface component. The self-healing layer includes polyurethane, polyester, epoxy, polyurethane microcapsules filled with di-n-butyltin dilaurate, and a polysiloxane mixture.

### BACKGROUND

Electronic devices, such as computers, laptops, tablets, and, smartphones have a touch-surface component, for example a touch pad and a touch screen. The touch-surface component of an electronic device functions as an input device through which a user can perform a variety of input operations on the electronic device. Input operation may be performed on the touch-surface component, for example, using a stylus pen or fingers.

### BRIEF DESCRIPTION OF DRAWINGS

The following detailed description references the drawings, wherein:

FIG. 1 illustrates a sectional view of a self-healing touch-surface component, according to an example implementation of the present subject matter;

FIG. 2 illustrates a sectional view of a self-healing touch-surface component, according to an example implementation of the present subject matter;

FIG. 3 illustrates a sectional view of a self-healing touch-surface component, according to an example implementation of the present subject matter;

FIG. 4 illustrates a sectional view of a self-healing touch-surface component, according to an example implementation of the present subject matter;

FIG. 5 illustrates a sectional view of a self-healing film, according to an example implementation of the present subject matter;

FIG. 6 illustrates a sectional view of a self-healing film, according to an example implementation of the present subject matter;

FIG. 7 illustrates a sectional view of a self-healing film, according to an example implementation of the present subject matter; and

FIG. 8 illustrates a method of fabricating a self-healing touch pad, according to an example implementation of the present subject matter.

### DETAILED DESCRIPTION

Touch-surface components, such as touch pads and touch screens, are commonly present on laptops, tablets, smartphones, and the like, through which users can operate such devices. Regular and rough usage of touch-surface components may lead to scratches on the surface of the touch-surface components. Significant or deep scratches may adversely affect the appearance, functionality and, hence, the user experience of the touch-surface components. The touch-surface components cannot afford to have scratches that affect their functionality.

The touch-surface components are generally retro-coated with a protection layer on top to protect the touch-surface components from scratches. Scratches, however, appearing on the protection layer may lead to frequent replacement of the protection layer. This may impose additional burden and cost on the users.

The present subject matter describes self-healing touch-surface components that can heal or repair scratches on their surface on their own. The present subject matter also describes methods of fabricating self-healing touch-surface components, such as self-healing touch pads. The present subject matter further describes self-healing films which when pasted on touch-surface components make the touch-surface component self-healable.

In accordance with the present subject matter, scratches on the touch-surface components can heal on their own substantially quickly, for example within 3 seconds, and over a wide temperature range starting from 5° C. The self-healing property of the touch-surface components makes them robust, and avoids use and replacement of retro-coatings with a protective layer on top, which provides a better user experience of the touch-surface components.

In an example implementation of the present subject matter, a self-healing touch-surface component includes a self-healing layer disposed over a touch-surface component. The self healing layer includes polyurethane, polyester, epoxy, polyurethane microcapsules filled with di-n-butyltin dilaurate, and a polysiloxane mixture. The polysiloxane mixture may be encapsulated or phase-separated and include poly-dimethylsiloxane, hexamethyldisiloxane, decamethylcyclopentasiloxane, hexamethylcyclotrisiloxane, poly-diethoxysiloxane, and a combination thereof. The chemical composition and concentrations of constituents in the self-healing layer enables self-healing of the self-healing touch-surface component within 3 seconds from the time of scratch and even at a low temperature of 5° C.

In an example implementation, the self-healing touch-surface component includes an anti-smudging layer coated on the self-healing layer. The anti-smudging layer includes at least one of polyurethane and acrylate resin in combination with metal fluorides. The anti-smudging layer on the self-healing touch-surface component helps in increasing the hardness of the self-healing layer and maintaining the cosmetic appearance of the self-healing touch-surface component.

The following detailed description refers to the accompanying drawings. Wherever possible, the same reference numbers are used in the drawings and the following description to refer to the same or similar parts. While several examples are described in the description, modifications, adaptations, and other implementations are possible. Accordingly, the following detailed description does not limit the disclosed examples. Instead, the proper scope of the disclosed examples may be defined by the appended claims.

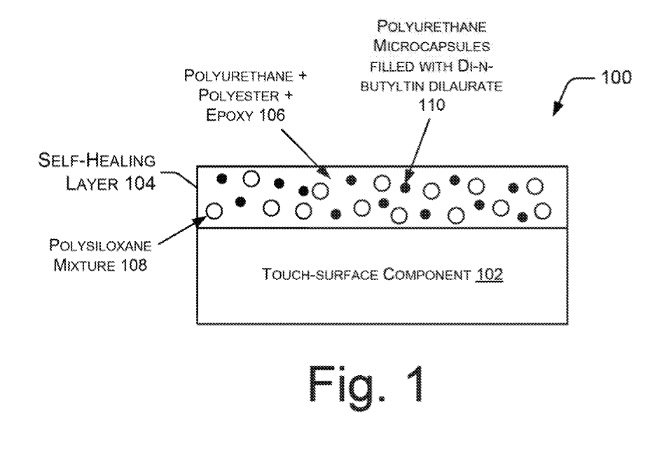

FIG. 1 illustrates a sectional view of a self-healing touch-surface component 100, according to an example implementation of the present subject matter. The self-healing touch-surface component 100 has a touch-surface component 102. The touch-surface component 102 may be a touch pad or a touch screen of an electronic device.

The self-healing touch-surface component 100 has a self-healing layer 104 on the touch-surface component 102. The self-healing layer 104 includes polyurethane, polyester and epoxy 106 in the form of a base matrix. The base matrix is embedded with a polysiloxane mixture 108 and polyurethane microcapsules filled with di-n-butyltin dilaurate 110. The polysiloxane mixture 108 may include poly-dimethylsiloxane, hexamethyldisiloxane, decamethylcyclopentasiloxane, hexamethylcyclotrisiloxane, poly-diethoxysiloxane, and a combination thereof. The polysiloxane mixture 108 may be encapsulated or phase-separated. The polysiloxane mixture may be encapsulated using a urea-formaldehyde encapsulation procedure. The polyurethane microcapsules may be polyurethane shells filled with di-n-butyltin dilaurate. The di-n-butyltin dilaurate may be mixed with chlorobenzene before encapsulating in the polyurethane microcapsules. The polyurethane microcapsules may be formed through an interfacial polymerization procedure.

In an example implementation, polyurethane in the self-healing layer 104 has a concentration in a range of 60% to 75%, polyester in the self-healing layer 104 has a concentration in a range of 10% to 15%, and epoxy in the self-healing layer 104 has a concentration in a range of 10% to 15%. Further, the polyurethane microcapsules in the self-healing layer 104 has a concentration in a range of 0.1% to 2%, and the polysiloxane mixture in the self-healing layer 104 has a concentration in a range of 2% to 3%.

In an example implementation, the self-healing layer 104 may have a thickness in a range of 10 μm to 30 μm. The self-healing layer 104 may be spray coated on the touch-surface component 102. In an example implementation, the surface of the touch-surface component 102 may be cleaned before coating the self-healing layer 104. Further, after coating the self-healing layer 104, the touch-surface component 102 may be heated at a temperature in a range of 70° C. to 80° C. for a time duration in a range of 20 minutes to 40 minutes for curing the self-healing layer 104.

The base matrix of polyurethane, polyester, and epoxy forms an interpenetrating macromolecular network that provides high impact strength, high toughness, and high wear resistance to the self-healing layer 104 and thus to the self-healing touch-surface component 100. The polysiloxane mixture 108 in the self-healing layer 104 functions as a healing agent, and di-n-butyltin dilaurate, filled in polyurethane microcapsules 110, functions as a catalyst for polymerization within the self-healing layer 104.

A scratch on the self-healing touch-surface component 100 damages the self-healing layer 104. The damage to the self-healing layer 104 ruptures the polyurethane microcapsules 110, which causes di-n-butyltin dilaurate to mix with the polysiloxane mixture 108, polyurethane, polyester, and epoxy within the self-healing layer 104. Mixing of di-n-butyltin dilaurate initiates polymerization within the self-healing layer 104 which heals the scratch within 3 seconds from the time of scratch and even, at a low temperature of 5° C.

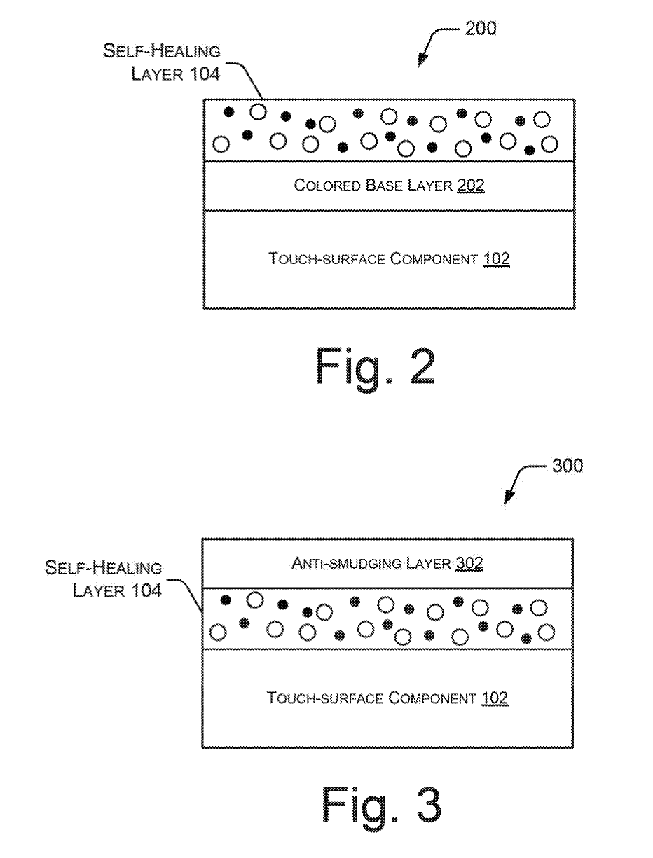

FIG. 2 illustrates a sectional view of a self-healing touch-surface component 200, according to an example implementation of the present subject matter. The self-healing touch-surface component 200, as shown, has a colored base layer 202 between the touch-surface component 102 and the self-healing layer 104. The self-healing layer 104 is the same as the self-healing layer described through the description of FIG. 1.

The colored base layer 202 includes acrylate, polyurethane, acrylate polyurethane, polycarbonate and cyclic olefin copolymer in combination with one of color dyes and color pigments. The colored base layer 202 provides color to the touch-surface component 102, for example, in the case of a touch pad of a laptop. The colored base layer 202 may be coated on the touch-surface component 102 through spray coating. After coating the colored base layer 202, the touch-surface component 102 may be heated at a temperature in a range of 80° C. to 150° C. for a time duration in a range of 20 minutes to 40 minutes for curing the colored base layer 202. In an example, implementation, the colored base layer 202 may have a thickness in a range of 5 μm to 15 μm.

FIG. 3 illustrates a sectional view of a self-healing touch-surface component 300, according to an example implementation of the present subject matter. The self-healing touch-surface component 300, as shown, has an anti-smudging layer 302 on the self-healing layer 104. The self-healing layer 104 is the same as the self-healing layer described through the description of FIG. 1.

The anti-smudging layer 302 includes at least one of polyurethane and acrylate resin in combination with metal fluorides. The anti-smudging layer 302 may be coated on the touch-surface component 102 through spray coating or by dipping in a metal fluoride composition. In an example implementation, the anti-smudging layer 302 may have a thickness in a range of 1 μm to 3 μm.

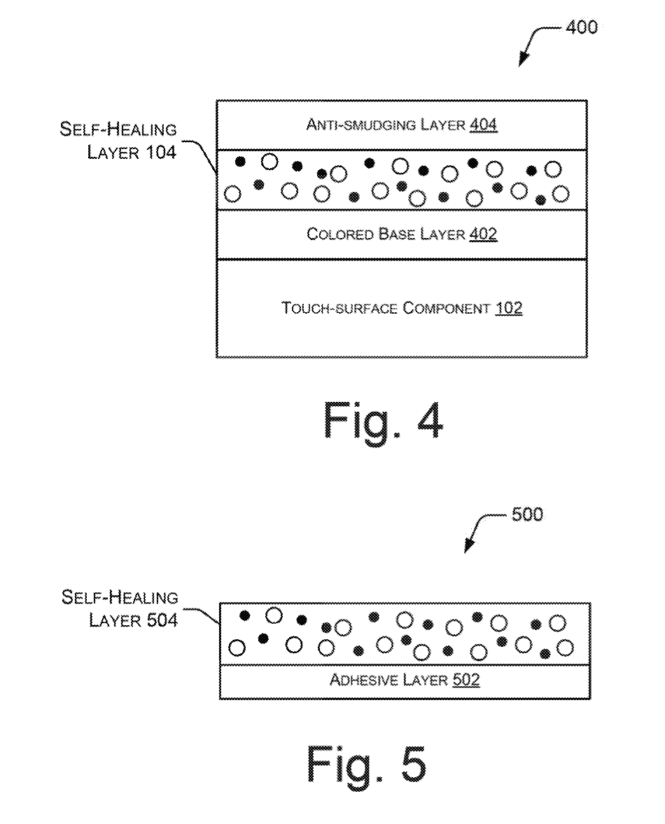

FIG. 4 illustrates a sectional view of a self-healing touch-surface component 400, according to an example implementation of the present subject matter. The self-healing touch-surface component 400, as shown, has a colored base layer 402 between the touch-surface component 102 and the self-healing layer 104. The self-healing touch-surface component 400 also has an anti-smudging layer 404 on the self-healing layer 104. The self-healing layer 104, the colored base layer 402, and the anti-smudging layer 404 are as described earlier with reference to FIGS. 1 to 3.

FIG. 5 illustrates a sectional view of a self-healing film 500, according to an example implementation of the present subject matter. The self-healing film 500 can be pasted on a touch-surface component, for example, a touch pad or a touch screen of an electronic device, to enable self-healing of the touch-surface component. A touch-surface component with the self-healing film 500 pasted on it can self-heal from scratches within 3 seconds from the time of scratch and over a wide temperature range starting from 5° C.

The self-healing film 500 includes an adhesive layer 502. The adhesive layer 502 may be coated on a substrate (not shown) through spray coating. The adhesive layer may have a thickness in a range of 1 μm to 10 μm, and includes acrylics, ethylene-vinyl acetate copolymers, polyamides, polyolefins, styrene copolymers, polyester, polyurethane, rubber-based adhesives, isocyanate based polymers, epoxy, and a combination thereof. The isocyanate based polymers may include polymeric methylene-4,4′-diphenyl diisocyanate (pMDI), urethanes, urea, and such.

The self-healing film 500 also includes a self-healing layer 504 on the adhesive layer 502. The chemical composition and the thickness of the self-healing layer 504 of the self-healing film 500 are the same as those for the self-healing layer 104 described earlier. In an example implementation, after coating the self-healing layer 504, the self-healing film 500 may be heated at a temperature in a range of 70° C. to 80° C for a time duration in a range of 20 minutes to 40 minutes for curing the self-healing layer 504.

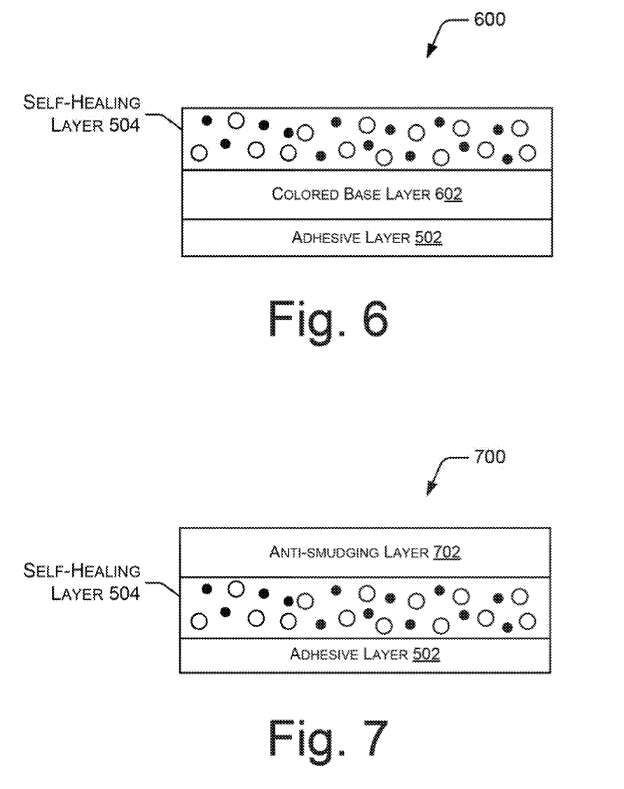

FIG. 6 illustrates a sectional view of a self-healing film 600, according to an example implementation of the present subject matter. The self-healing film 600, as shown, has a colored base layer 602 between the adhesive layer 502 and the self-healing layer 504. The self-healing layer 504 is the same as the self-healing layer 104 described through the description of FIG. 1. The colored base layer 602 is the same as the colored base layer 202 described through the description of FIG. 2. The self-healing film 600 with the colored base layer 602 between the adhesive layer 502 and the self-healing layer 504 may be used for touch pads.

FIG. 7 illustrates a sectional view of a self-healing film 700, according to an example implementation of the present subject matter. The self-healing film 700, as shown, has an anti-smudging layer 702 on the self-healing layer 504. The self-healing layer 504 is on the adhesive layer 502. The self-healing layer 504 is the same as the self-healing layer 104 described through the description of FIG. 1. The anti-smudging layer 702 is the same as the anti-smudging layer 302 described through the description of FIG. 3.

In an example implementation, the self-healing film (not shown) may include a colored base layer between the adhesive layer and the self-healing layer, and include an anti-smudging layer on the self-healing layer. The self-healing layer, the colored base layer, and the anti-smudging layer are as described earlier with reference to FIGS. 1 to 3.

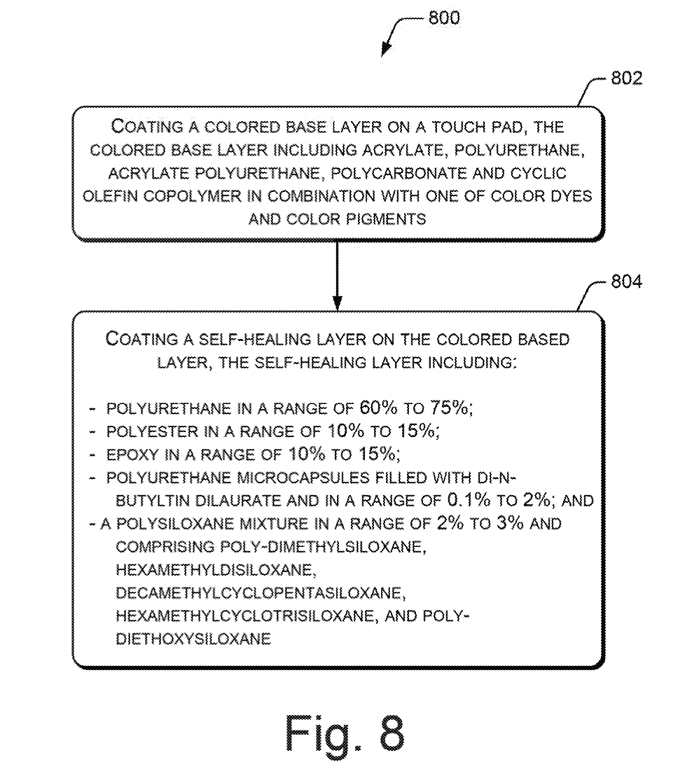

FIG. 8 illustrates a method 800 of fabricating a self-healing touch pad, according to an example implementation of the present subject matter. At block 802 of the method 800, a colored base layer is coated on a touch pad. The colored base layer includes acrylate, polyurethane, acrylate polyurethane, polycarbonate and cyclic olefin copolymer in combination with one of color dyes and color pigments. The colored base layer may be coated on the touch pad through spray coating, and may have a thickness in a range of 5 μm to 15 μm.

In an example implementation, the surface of the touch pad may be cleaned before coating the colored base layer. In an example implementation, after coating the colored base layer, the touch pad may be heated at a temperature in a range of 80° C. to 150° C. for a time duration in a range of 20 minutes to 40 minutes for curing the colored base layer.

At block 804, a self-healing layer is coated on the colored based layer, where the self-healing layer includes polyurethane in a range of 60% to 75%, polyester in a range of 10% to 15%, epoxy in a range of 10% to 15%, polyurethane microcapsules filled with di-n-butyltin dilaurate and in a range of 0.1% to 2%, and a polysiloxane mixture in a range of 2% to 3% and comprising poly-dimethylsiloxane, hexamethyldisiloxane, decamethylcyclopentasiloxane, hexamethylcyclotrisiloxane, and poly-diethoxysiloxane. The polysiloxane mixture may be encapsulated or phase-separated. The self-healing layer may have a thickness in a range of 10 μm to 30 μm.

In an example implementation, the self-healing layer may be deposited on the colored base layer through spray coating. Further, after coating the self-healing layer, the touch pad may be heated at a temperature in a range of 70° C. to 80° C. for a time duration in a range of 20 minutes to 40 minutes for curing the self-healing layer.

Further, in an example implementation, an anti-smudging layer may be coated on the self-healing layer of the touch pad. The anti-smudging layer may be through one of spray coating and dipping in a metal fluoride composition. The anti-smudging layer may have a thickness in a range of 1 μm to 3 μm and include at least one of polyurethane and acrylate resin in combination with metal fluorides.

Although implementations for self-healing touch-surface components, self-healing films, and methods of fabrication of self-healing touch pads have been described in language specific to methods and/or structural features, it is to be understood that the present subject matter is not limited to the specific methods or features described. Rather, the methods and specific features are disclosed and explained as example implementations for self-healing touch-surface components, self-healing films, and methods of fabrication of self-healing touch pads.

We claim:

1. A self-healing touch-surface component of an electronic device, the self-healing touch-surface component comprising:
a self-healing layer disposed over a touch-surface component, the self-healing layer including polyurethane, polyester, epoxy, polyurethane microcapsules filled with di-n-butyltin dilaurate, and a polysiloxane mixture.

2. The self-healing touch-surface component of claim 1, wherein:
polyurethane is in a range of 60% to 75%;
polyester is in a range of 10% to 15%;
epoxy is in a range of 10% to 15%;
the polyurethane microcapsules is in a range of 0.1% to 2%; and
the polysiloxane mixture is in a range of 2% to 3%.

3. The self-healing touch-surface component of claim 1, wherein the polysiloxane mixture comprises poly-dimethylsiloxane, hexamethyldisiloxane decamethylcyclopentasiloxane, hexamethylcyclotrisiloxane, and poly-diethoxysiloxane.

4. The self-healing touch-surface component of claim 1, wherein the self-healing layer has a thickness in a range of 10 μm to 30 μm.

5. The self-healing touch-surface component of claim 1, further comprising a colored base layer between the touch-surface component and the self-healing layer, wherein the colored base layer includes acrylate, polyurethane, acrylate polyurethane, polycarbonate and cyclic olefin copolymer in combination with one of color dyes and color pigments.

6. The self-healing touch-surface component of claim 5, wherein the colored base layer has a thickness in a range of 5 μm to 15 μm.

7. The self-healing touch-surface component of claim 1, comprising an anti-smudging layer coated on the self-healing layer, wherein the anti-smudging layer includes at least one of polyurethane and acrylate resin in combination with metal fluorides.

8. The self-healing touch-surface component of claim 7, wherein the anti-smudging layer has a thickness in a range of 1 μm to 3 μm.

9. A self-healing film for a touch-surface component of an electronic'device, the self-healing film comprising:
an adhesive layer having a thickness in a range of 1 μm to 10 μm; and
a self-healing layer on the adhesive layer, having a thickness in a range of 10 μm to 30 μm, wherein the self-healing layer includes polyurethane, polyester, epoxy, polyurethane microcapsules filled with di-n-butyltin dilaurate, and a polysiloxane mixture.

10. The self-healing film of claim 9, wherein the polysiloxane mixture comprises poly-dimethylsiloxane, hexamethyldisiloxane, decamethylcyclopentasiloxane, hexamethylcyclotrisiloxane and poly-diethoxysiloxane.

11. The self-healing film of claim 9, wherein:
polyurethane is in a range of 60% to 75%;
polyester is in a range of 10% to 15%;
epoxy is in a range of 10% to 15%;
the polyurethane microcapsules is in a range of 0.1% to 2%; and
the polysiloxane mixture is in a range of 2% to 3%.

12. The self-healing film of claim 9, further comprising an anti-smudging layer coated on the self-healing layer, wherein the anti-smudging layer has a thickness in a range of 1 μm to 3 μm and includes at least one of polyurethane and acrylate resin in combination with metal fluorides.

13. A method of fabricating a self-healing touch pad, the method comprising:
coating a colored base layer on a touch pad, the colored base layer including acrylate, polyurethane, acrylate polyurethane, polycarbonate and cyclic olefin copolymer in combination with one of color dyes and color pigments; and
coating a self-healing layer on the colored based layer, the self-healing layer including:
polyurethane in a range of 60% to 75%;
polyester in a range of 10% to 15%;
epoxy in a range of 10% to 15%;
polyurethane microcapsules filled with di-n-butyltin dilaurate and in a range of 0.1% to 2%; and
a polysiloxane mixture in a range of2% to 3% and comprising poly-dimethylsiloxane, hexamethyldisiloxane, decamethylcyclopentasiloxane, hexamethylcyclotrisiloxane, and poly-diethoxysiloxane.

14. The method of claim 13, wherein coating the self-healing layer comprises:
depositing the self-healing layer on the colored base layer through spray coating; and
heating the touch pad at a temperature in a range of 70° C. to 80° C. for a time duration in a range of 20 minutes to 40 minutes.

15. The method of claim 13, further comprising coating an anti-smudging layer on the self-healing layer through one of spray coating and dipping in a metal fluoride composition, wherein the anti-smudging layer includes at least one of polyurethane and acrylate resin in combination with metal fluorides.
